(19) United States
(12) Patent Application Publication
(10) Pub. No.: US 2005/0266324 A1
(43) Pub. Date: Dec. 1, 2005

(54) Image bearing body, a method of producing the same, a method of cleaning the same and an image forming apparatus

(76) Inventors: Nobuaki Kobayashi, Tokyo (JP); Yoshihiko Eto, Tokyo (JP)

Correspondence Address: CANTOR COLBURN, LLP, 55 GRIFFIN ROAD SOUTH, BLOOMFIELD, CT, 06002, US

(21) Appl. No.: 10/853,699

(22) Filed: May 25, 2004

(51) Int. Cl. G03G 5/047; G03G 5/147

(52) U.S. Cl. 430/58.05; 430/56; 430/66; 430/132; 430/127

(57) ABSTRACT

An electrophotographic image bearing body comprising a base and a surface layer disposed over the base, wherein the end track of the surface layer undulates or inclines with respect to the outer circumference line of the image bearing body, and a method for producing the same and an image forming method employing the same.

### BACKGROUND

1. Technical Field

The invention relates to an image bearing body, a method of producing the same, a method of cleaning the same and an image forming apparatus, in particular, an organic photoreceptor, a method of producing the same, a method of cleaning the same and an image forming apparatus.

2. Related Art

A cylindrical photoreceptor (sometimes referred to as cylindrical image bearing body hereinafter) is generally manufactured by coating a photosensitive layer coating solution or the like onto a base using an immersion coating method and then drying, but in the coat drying step, liquid accumulation due to downward flow of the coating solution to the lower end of the base will occur. If drying is done in this state, a thick film portion is formed at the accumulated liquid portion of the lower end of the cylindrical photoreceptor. When this type of cylindrical photoreceptor is used in an image forming apparatus, stripping from the accumulated liquid portion will occur and this may cause cleaning problems or make image defects likely to occur. Thus a method has been proposed for eliminating the cylindrical receptor lower end (a portion unnecessary for image formation) that includes the accumulated liquid portion.

The methods for eliminating the coating layer of this cylindrical receptor lower end include: a method in which the cylindrical photoreceptor lower end is immersed in a solvent and oscillated using supersonic waves (Japanese Patent Laid-open Publication No. 63-311357) a method for scraping with a brush (3-60782, 4-141663, 5-142789, 10-207084, 11-184100 and 11-194509) and the like, as well as a method of elimination using tape. Examples of known methods which use tape include: the method of elimination in which a non-woven heat sealing tape is sequentially unwound, and then this tape is brought in contact with the photoreceptor drum to remove the photosensitive layer (Patent Publication 4-65376); a method for removal in which tape formed from twill that has been impregnated with a solvent, is unwound and then brought in contact with the photoreceptor drum (Japanese Patent Laid-open Publication 6-138670); and a method using tape formed of a non-woven material which has a roughness on one surface (Japanese Patent Laid-open Publication 9-281725).

However, when the cylindrical photoreceptor produced as described above is loaded in an image forming apparatus and a performance test is done, cleaning problems such as frequent toner transfer faults on the end of the image and image defects also occur. When the reason for this was investigated, it was confirmed that the cleaning blade receives a strong cutting force at the coating layer cut portion of the cylindrical receptor lower end, and at this portion the abrasion and cutting of the cleaning blade is great, and as a result cleaning problems arise and image defects are caused at the image end.

This phenomenon is one where in the case of a cylindrical photoreceptor that includes inorganic particles in the photosensitive layer or in the intermediate layer, or a cylindrical photoreceptor using a thermosetting resin, more abrasion and cutting of the cleaning blade is seen, and cleaning defects occur easily. That is to say, it is desirable to solve the problem of cleaning defects caused by the cut layer portion of the coating layer end, whether the image bearing body is belt shaped or cylindrical, which results from removing the coating layer of the unnecessary portion of the accumulated liquid portion.

### SUMMARY

An electrophotographic image bearing body comprising a base and a surface layer disposed over the base, wherein the surface layer end track undulates or inclines with respect to the outer periphery (circumference) line, and a method for producing the same and an image forming method for employing the same.

### BRIEF DESCRIPTION OF THE DRAWINGS

The present invention will become more fully understood from the detailed description given herein below and the accompanying drawings which are given by way of illustration only, and thus are not intended as a definition of the limits of the present invention, and wherein:

FIG. 1(a) shows an example of a configuration in which the coating layer end track neither undulates nor inclines in the circumferential direction;

FIG. 1(b) shows an example of a configuration in which the coating layer end track undulates or inclines in the circumferential direction;

FIGS. 2(a)-(e) show various examples various coating layer end tracks;

FIGS. 3(a)-(e) are expanded views showing examples in which coating layer end track undulates or inclines in the circumferential direction;

FIGS. 4(a) and (b) are a cross-sections of a coating layer removal apparatus for removal by brush;

FIG. 5 is an example showing a state in which a cylindrical image bearing body and a sliding member are in contact with each other;

FIG. 6 shows an overall structure of the coating layer removal apparatus;

FIG. 7 is a cross-sectional view of an example of the image forming apparatus of this invention; and

FIG. 8 is a cross-sectional view of another example of the image forming apparatus of this invention.

### DETAIL DESCRIPTION OF EXEMPLARY EMBODIMENTS

In the present invention, in the image bearing body, the coating layer end track undulates or inclines with respect to the outer peripheral line (also referred to as circumferential line hereinafter) of the surface that is perpendicular to the rotational axis.

That is to say, the end track from removal of the unnecessary portions of the coating layer formed on the base, undulates or inclines with respect to the outer circumferential direction. As a result, the position of contact of the cut layer of the coating layer end and the cleaning blade constantly varies with the rotation of the image bearing body, and this causes wear and cutting of the cleaning blade at the position of contact.

In the present application, the image bearing body is a body which is capable of bearing a toner image obtained from developing an electrostatic latent image in electrophotographic image processing. Examples include a photoreceptor in which an electrostatic latent image is formed, the latent image is developed and then the toner image is formed; an intermediate transfer member in which the toner image is temporarily transferred from the photoreceptor and fixed onto a image recording material or transferred to another member; an intermediate transfer member in which the toner image is transferred again from the other intermediate transfer member. The configuration of these image bearing bodies is not particularly limited, and may be formed of a cylindrical base, a flexible base or may be belt-shaped. In this embodiment, it is preferable that the invention is applied to the cylindrical photoreceptor.

The image bearing body of the present embodiment is mainly described as the cylindrical photoreceptor, but this description is not intended to exclude the various configurations of the present embodiment.

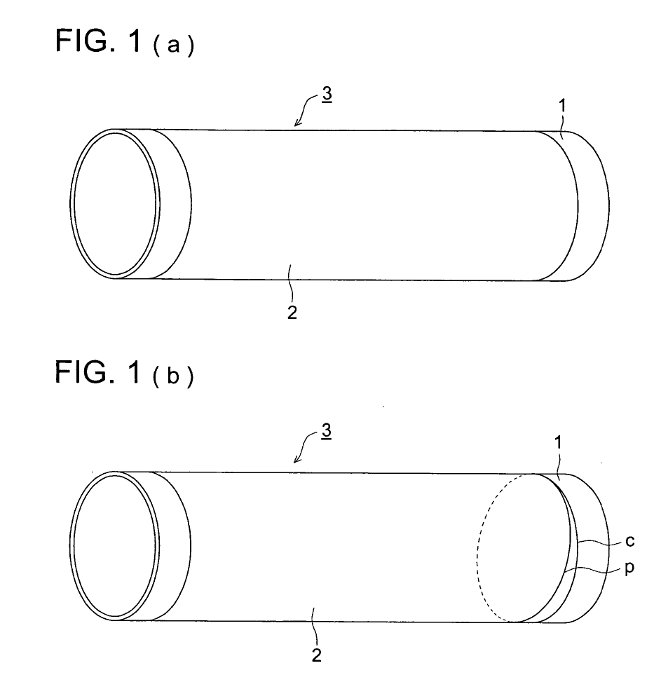

FIG. 1 is used to explain the coating layer end track being undulated or inclined in the circumferential direction. It is to be noted that coating layer refers to layers such as: an organic photosensitive layer of a silicone or the like; a charge generating layer of an organic separate type photoreceptor; a photosensitive layer including a charge transferring layer, an intermediate layer; and a surface protecting layer, and all layers coated onto the base according to need.

Cylindrical photoreceptor 3 has the configuration shown in the perspective view of FIG. 1(a), and a photosensitive layer, and if necessary a coating layer 2 such as an intermediate layer or a surface protection layer are disposed on the surface of the conductive base 1 which has a drum-like configuration. It is preferable that at least one of the coating layers on the cylindrical photoreceptor is completely removed, but the hard intermediate layer or the like may sometimes remain.

Here the meaning of the end track being undulated or inclined with respect to the outer periphery (circumference) will be described using examples. Here, with respect to the outer periphery (circumference) has the same meaning as the circumferential direction referred to hereinafter.

FIG. 1(b) shows the coating layer end track after the coating layer having the accumulated liquid portion of the lower end of the cylindrical photoreceptor has been removed. The solid line c in FIG. 1(b) is a circumferential line of a circumferential surface that is perpendicular to the central axis of the cylindrical base. The end track achieved using the method for removing a coating film known hitherto is formed on this circumference. However, the end track for the coating layer shown by solid and broken line p shows an incline which is not parallel to the inner surface which is perpendicular to the central axis, and refers to the end track formed on this type of incline p, and shows that the end track of the coating layer is inclined with respect to the circumferential line.

In the case where the image bearing body is belt-shaped, the circumferential line may be thought of in the same manner. That is to say, the circumferential line should be seen as the outer circumference of the surface which is perpendicular to the rotation axis of the roller or the like which extends and spans the image bearing body.

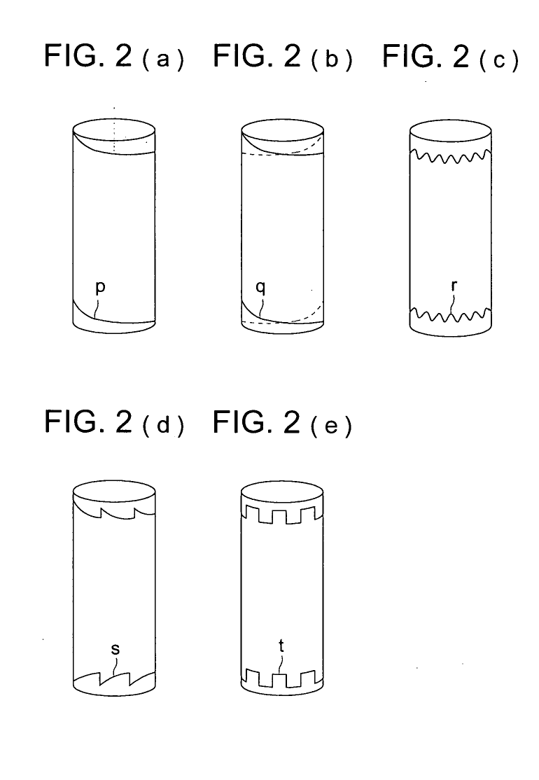

FIG. 2 shows various examples of the coating layer end track. FIGS. 2(a) and (b) show the inclined end tracks p and q, FIGS. 2(c), (d) and (e) show the undulating end tracks r, s and t. The present invention may also have comb-like undulations as in FIG. 2(e).

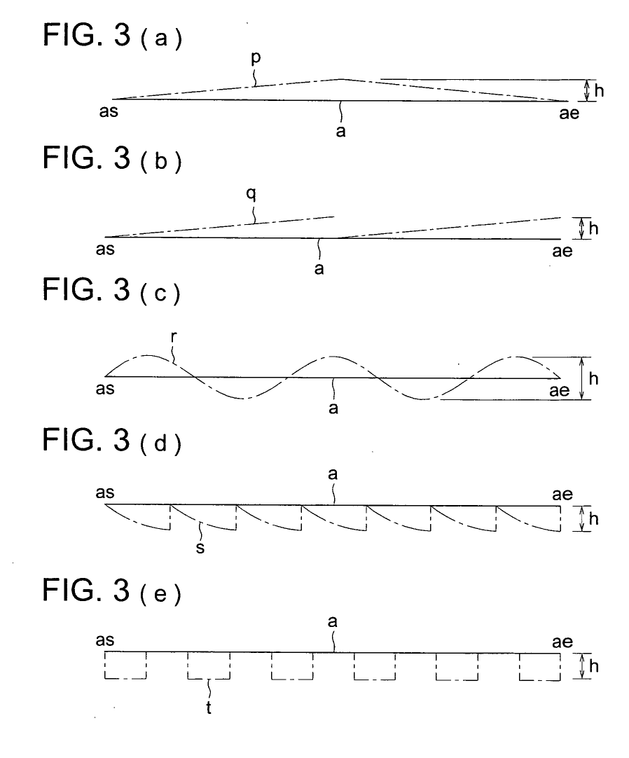

An example in which the coating end track undulates or inclines with respect to the circumferential line will be described using the expanded diagram of FIG. 3(a). In FIG. 3(a), the circumferential line of the circumferential surface which is perpendicular to the central axis of the cylindrical base is shown as a, which is a horizontal line. The points as and ae on the horizontal line show the same points on the circumferential line. Examples of the coating layer end tracks which incline in the cylindrical base central axis direction with respect to the circumferential line are the dot-chain lines p and q in FIGS. 3(a) and (b), and end tracks shown by wave-like chain-dot lines in r, s, and t in FIGS. 3(a), (b) and (c) which are undulating in the circumferential direction. That is to say, the coating layer end track which undulates or inclines in the circumferential direction of this invention does not need to be in one direction, and there may be some unconnected points.

If the undulation or the incline of the end track is described using FIGS. 3(a)-(e) as examples, then it is the maximum vertical interval due to the undulation or incline of the end track, or in other words, the interval shown by h in the drawings.

In this invention, the maximum value of the undulation width or incline width is preferably not less than 0.5 mm and not more than 10 mm. A value of not less than 2 mm and not more than 8 mm is even more preferable. By the value being not less than 0.5 mm the effect of preventing wear and cutting due the abutting of the cleaning blade and the end track cut layer becomes greater, and thus the effect of preventing the generation of cleaning defects is also greater. By the value being not more than 10 mm, the image formation width of the photoreceptor is suitably maintained, and region for effective image formation can be secured.

In the cylindrical photoreceptor having the above-described type of coating layer end track, even when the toner is removed using a cleaning blade, the contact position of the cleaning blade and the coating layer end track constantly varies with the rotation of the photoreceptor, and abrasion and cutting of the cleaning blade does not occur at the contact position, thus preventing occurrence of cleaning defects and image defects.

On the other hand, a cleaning device is known in which the length of the cleaning blade is comparatively short, and which has a seal member which comprises a molt plane or the like at the end of the cleaning blade (For example, Japanese Patent Laid-open 05-61390), and the coating layer end track sometimes contacts the seal member, and in this case also, when the coating layer end track always comes in contact at the same position, the seal member naturally wears and cuts, and thus in this case also, the same effects are exhibited as those of the above-described cleaning blade.

Next, the method for forming a coating layer end track which undulates or inclines in the circumferential direction will be described.

The coating layer removal method for forming the coating layer end track is not particularly limited.

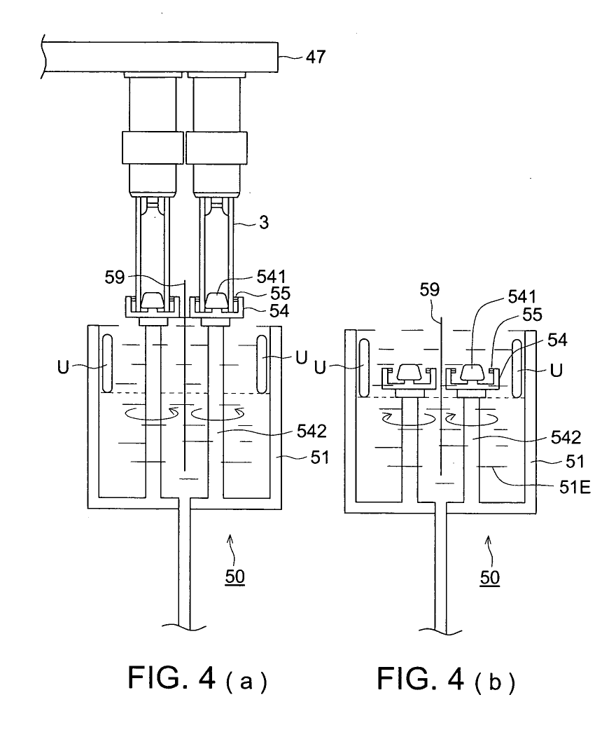

The following is a description of the method for forming the coating layer end track of this invention using method for removal using a brush as an example. Method for removing a coating layer using a brush FIG. 4 is a cross-sectional view of an example of a coating layer removal apparatus which uses a brush. In the drawings 3 is cylindrical photoreceptor which has a coating layer formed on its surface. This cylindrical photoreceptor is movable upward and downward by a conveying means 47 (the cylindrical photoreceptor is conveyed by a coating layer coating step which is not shown), and contacts the sliding member 55 which is provided at the coating layer removal table (coating removal means) 54 of the coating removal apparatus 50. The coating layer removal table 54 also has a sponge-like base holding member 541, and the cylindrical photoreceptor 3 is interposed between the base holding member 541 and the sliding member 55 on the coating layer removal table 54. Also, the coating layer removal table 54 is designed so as to be rotatable by being driven by a motor or the like. The cylindrical photoreceptor 3 is installed in the coating layer removal table 54 by a conveying means 47 that has gripping means (O-ring chuck, air picker chuck etc.) for gripping the base inner portion and in which the lower end of the cylindrical photoreceptor 3 contacts the sliding member 55 (FIG. 4(a)). At this time, the coating layer removal table 54 has come out of a solvent tank 51 which is the washing means. When the solvent remaining from the end coating layer of the cylindrical photoreceptor is less than 60 mass %, the coating layer removal table 54 is rotated. (The cylindrical photoreceptor may also be rotated. That is to say, the cylindrical photoreceptor may be rotated relative to the sliding member 55.) The cylindrical photoreceptor is moved vertically at the same time that it is being rotated (the coating layer removal table is moved vertically due to the rotation of the cylinder 542), and the coating layer of the coating layer of the end portion is taken off by the sliding member 55. The coating layer end tracks p-s shown in FIG. 3(a)-(d) are formed by the vertical movement of the coating layer removal table.

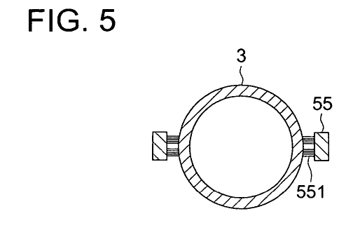

FIG. 5 is a vertical cross-section showing a state of contact between the cylindrical photoreceptor 3 and the sliding member 55. The cylindrical photoreceptor 3 is in contact with the brush 551 of the sliding member. The sliding member 55 is at relatively the same position on the both ends of the cylindrical photoreceptor 3, and if the cylindrical photoreceptor is gradually moved upwards at the time of rotation of the sliding member, the end track will be formed like q of 3(b), and if in addition to this movement, the cylindrical photoreceptor is moved upwards and downwards, the end track will be like s of 3(d). Also, if one brush 551 of the sliding member is used, and the cylindrical photoreceptor is caused to make ½ rotation upward and half rotation downward at the same time of the rotation of the sliding member, the end track will be formed like p in FIG. 3(a), and if at the same time as the rotation of the sliding member, the upward and downward movement on the photoreceptor is repeated, the end track will be like r of FIG. 3(c).

At the start of the coating layer removal, the amount of remaining solvent in the coating layer is preferably not more than 60 mass % and not less than 3 mass %. The amount of remaining solvent is determined by considering the amount of solvent included directly after the formation of the coating layer (when a plurality of layers are being coated, the amount directly after the last layer is coated) as 100%, and is the mass % amount that remains in the layer.

When the removal is complete, the cylindrical photoreceptor is lifted by the conveying means 47 (which includes a separation means) and is separated from the coating layer removal table 54 and then dried. The cylindrical photoreceptor having the coating layer end track of this invention is produced in this manner. However, due to the rotation of the cylinder (the moving means for the coating layer removal means) 542 which makes upward and downward movement of the coating layer removal table 54 possible, the coating layer removal table 54 is immersed in solvent 51E in the solvent tank 51 which is the cleaning means (FIG. 4(b)), and in the solvent tank, by combining the upward and downward movement of the coating layer removal table due to the ultrasonic-wave cleaning device and the cylinder with the rotation movement, the entire coating layer removal table including the sliding members is cleaned. Subsequently, due to another rotation of the cylinder 542, the coating layer removal table is lifted up to the liquid surface level of the solvent tank 51 to thereby prepare for another coating removal. In addition, it is preferable that an ultrasonic oscillator U is installed inside the solvent tank to increase the cleaning efficacy of the coating layer removal means. It is to be noted that as shown in FIG. 4, if more than 2 coating layers are removed simultaneously, it is preferable to provide a partition plate 59 between each of the coating layer removal means in order to prevent the occurrence of defects due to the rebound and the like during the coating layer removal from the cylindrical photoreceptor 3.

The material of the sliding member may be, brush, sponge, fabric, or a polymer fiber fabric, but brush is preferable.

The material of the brush is preferably nylon, polyethylene, polypropylene, polyester or the like. The size of one hole into which the brush will be planted on the coating layer removal table 54 is in the range of 0.5-2 mm, and the interval between the holes is about 1-3 mm. The width of the entire brush is preferably such that it corresponds with the width of the coating layer to be removed.

In this invention, even if the material of the sliding member for solvent saturation is not saturated by the solvent, it is sufficient that it carries the solvent. If the saturation amount of the sliding member when dry is 100 parts by mass, the mass of the sliding member for solvent saturation is preferably 105-200 parts by mass.

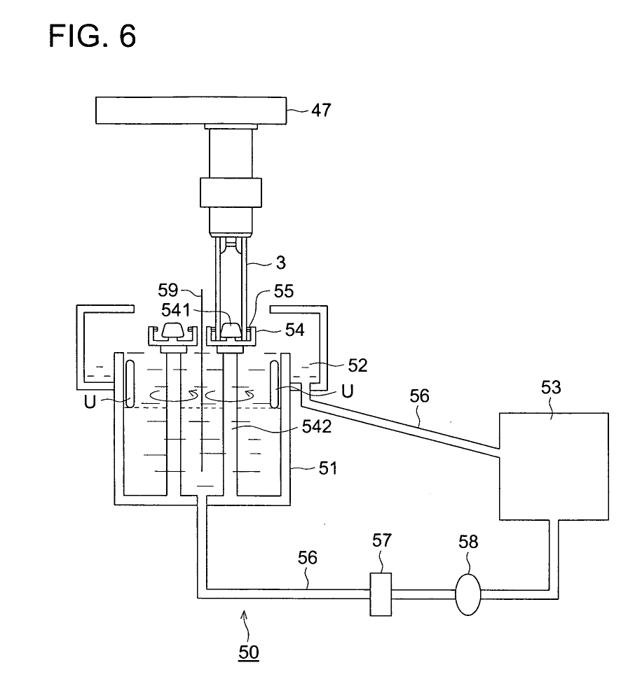

FIG. 6 shows the overall structure of the coating layer removal apparatus 50. The coating layer removal apparatus 50 comprises: a solvent tank 51, a solvent overflow chamber 52, a filling tank 53, a coating layer removal table 54, a brushing member 55, a solvent circulation pipe 56, a pump 57, a filter 58, a conveying means 47 and the like.

The brushing member 55 and the base holding member 541 are attached to the coating layer removal table 54, and when the cylindrical photoreceptor 3 is fixed, due to the simultaneous rotation and upward and downward movement of the coating layer removal table 54, the lower end coating layer of the cylindrical photoreceptor is taken off and removed. It is to be noted that as shown in FIG. 6, the coating layer removal table 54 is designed so as to be moveable in and out of the solvent tank due to the sliding member 55 and the like, as well as the rotation of the cylinder 542.

Although it has been stated that 542 rotates, it appears to be integral with 51 in the drawing. Does it rotate along with 51 If it is not, there is a distinction at the connection point of 542 and 51.

The solvent in the solvent tank is continually supplied from the supply tank via the solvent circulation pipe 56, and a filter is provided at some point inside the circulation pipe so that the solvent can sufficiently clean the coating layer removal means, and the coating layer components are thereby removed.

It is to be noted that solvent used at the time of the removal varies in accordance with the type of coating layer, but examples thereof are tetrahydrofuran, methanol, chloroform, methylene chloride, MEK (methyl ethylene ketone), esters such as acetone, alcohols, chlorine solvents, and ketone solvents mixed solvents thereof.

The method for forming the coating layer removal end may be a removal method using extraction tape. The extraction method using extraction tape is one in which the extraction tape is saturated with a solvent that will dissolve or swell the coating layer, and this is brought in contact with the coating layer of the cylindrical photoreceptor which rotates. At the same time of the rotation of the cylindrical photoreceptor, if movement in the central axis of the photoreceptor is also done, the various coating layer end track patterns shown in p-s of FIGS. 3(a)-(d) can be formed.

The material of the extracting tape is preferably one with which the solvent used can be saturated. Also the material which may be used is not particularly limited providing that the material does not penetrate the solvent used, and it can withstand the tension at the time of extraction. Specific examples of materials that can be used include: poly amide fibers such as 6 nylon fiber and 66 nylon fiber, polyester fibers such as polyethylene teraphthalate fibers and polybutylene teraphthalate fibers, acrylic fibers, vinylon fibers, vinylden fibers, polyurethane fibers, fluorine fibers, aromatic polyamide fibers, polyethylene fibers, and synthetic fibers of polyolefin fibers such as polypropylene fibers, regenerated fibers such as rayon fibers, semi-synthetic fibers such as acetate fibers and the like, inorganic fibers such as carbon fibers and the like, plant fibers such as cotton fiber and hemp fiber, and animal fiber such as wool.

The saturation solution used for saturating the extraction tape differs in accordance with the type of coating layer, but is not particularly limited providing that it dissolves or swells the coating layer to thereby remove it, and the above-described substance may be used.

Next the photoreceptor will be described.

The photosensitive body may be an inorganic photosensitive body or an organic photosensitive body.

The inorganic photosensitive body is, for example, an amorphous silicon photosensitive body. The amorphous silicon photosensitive body is a photosensitive body that has an amorphous silicon layer or a non-crystalline silicon layer. The amorphous silicon photosensitive body used may be a known amorphous silicon photosensitive body of Japanese Patent Laid-open Publication 54-83746, Japanese Patent Laid-open Publication 57-11556, Japanese Patent Laid-open Publication 60-67951, Japanese Patent Laid-open Publication 62-168161, and Japanese Patent Laid-open Publication 57-158650. The amorphous silicon photosensitive body (also referred to as a-Si photosensitive body hereinafter) may be formed by on a conductive support body (base), a photoconductive layer which is photoconductive and contains a-Si:H, X; an amorphous silicon surface layer; and an amorphous silicon anti-charge-injection layer. Also, in other examples the amorphous silicon photosensitive body is formed by, on a conductive support body; a charge-generating layer comprising a-Si:H, which forms photoconductive layer; a charge generating layer comprising halogen atoms X, and a charge transferring layer; and an amorphous silicon surface layer and a silicon anti-charge-injection layer.

The layer structures of the above described a-Si photosensitive are typical structures, and the surface layer and the silicon anti-charge-injection layer shown in the above does not necessarily need to be provided.

The a-Si photosensitive body is generally formed by heating a conductive support body at 50-400° C., and forming a photoconductive layer comprising a-Si using a film forming method such as a vacuum vapor deposition method, a spattering method, an ion plating method, a heat CVD method, a light CVD method, or a plasma CVD method (referred to hereinafter as PCVD method). Among these, the PCVD method in which the gas material is decomposed using direct current or high frequency waves or microwave glow discharge, and an a-Si deposited film is formed in the support body, is favorable.

Photoconductive Layer

In the a-Si photosensitive body, an under layer is preferably formed on the photoconductive body if necessary, to thus form a part of the photosensitive layer. The photoconductive layer is formed such that the conditions for suitable film formation parameters can be set in order to obtain desired characteristics using the vacuum deposition film formation method. More specifically, various thin film deposition methods may be used to form the photoconductive layer such as a glow discharge method (alternating current discharge CVD methods such as low frequency wave CVD method, high frequency wave CVD method, or microwave CVD method), a spattering method, a vacuum vapor deposition method, an ion plating method, a light CVD method, a thermal CVD method. These methods for thin film formation can be suitably selected and employed based on factors such as production conditions, the negative charge level of the capital investment level of the facility, the production scale, special characteristics desired of the photosensitive body for the image forming apparatus that is being produced, and the like. However, the glow discharge method is favorable in view of the fact that it is relatively easy to control the conditions for producing a photosensitive body for an image forming apparatus that has special desired characteristics. Examples of the substance that may be used as the Si supply gas for preparing the a-Si photosensitive body is a substance in which gaseous or gasified silicon hydride (type of silane) is effectively used; and SiH₄ and Si₂H₆ are preferable in view of easy handling when the layer is being prepared, and for efficient Si supply.

In the a-Si photosensitive body, the thickness of the conductive layer is determined in accordance with the appropriate requirements in view of obtaining desired electrophotographic and economic effects, and is preferably 20-50 μm, more preferably 23-45 μl and is optimally 25-40 μm.

Surface Layer

In the a-Si photosensitive body, it is preferable that a surface layer is also formed on the photoconductive layer that is formed on the conductive support body as described above. This surface layer has a free surface is mainly provided with the object of moisture resistance, continuous repeated use, electrical resistance; characteristics of the environment for use, durability and the like.

Amorphous silicon (a-Si) material; amorphous silicon material that includes hydrogen atoms (H) and/or halogen atoms (X) and further includes carbon atoms (denoted as “a-SiC:H, X” hereinafter); amorphous silicon that includes hydrogen atoms (H) and/or halogen atoms (X), and further includes oxygen atoms (denoted as “SiO:H, X” hereinafter); amorphous silicon that includes hydrogen atoms (H) and/or halogen atoms (X), and further nitrogen atoms (denoted as “a-SiN:H, X” hereinafter); or amorphous silicon that includes hydrogen atoms (H) and/or halogen atoms (X), and further includes at least one of carbon atoms, oxygen atoms and nitrogen atoms (denoted as “a-SiCON:H, X” hereinafter) may be favorably used as the material for the surface layer.

In addition, by including fluorine in an amount controlled so as to be within a range not less than 0.01 atom percent and not more than 15 atom percent, the bond generation of the silicon atoms and the carbon atoms in the surface layer may be more effectively achieved. In addition, the fluorine atoms in the surface layer function to effectively prevent the splitting of the bond between the silicon atoms and the carbon atoms due to corona damage and the like.

The amount of fluorine atoms and hydrogen atoms included in the surface layer is controlled in accordance with the rate of flow of H₂ gas, the temperature of the conductive support body, the discharge power and the gas pressure. The thickness of the surface layer in the a-Si photosensitive body is preferably 0.01-3 μm for normal thickness, 0.05-2 μm for favorable thickness and 0.1-1 μm for optimal thickness.

In the a-Si photosensitive body, providing a blocking layer (lower surface layer) before the photoconductive layer in which the amount of carbon atoms, oxygen atoms, and nitrogen atoms included in the layer is less than the amount in the surface layer, further improves characteristics such as electric capacity.

Anti-Charge-Injection Layer

In the a-Si photosensitive body, it is even more effective to dispose between the conductive support body and the photoconductive layer, an anti-charge-injection layer which functions to prevent the injection of charge from the conductive support body-side. That is to say, when the photosensitive layer receives constant polarity charge processing on the free surface, the anti-charge-injection layer prevents charge injection to the photoconductive layer from the conductive support body, and when charge processing of the opposite polarity is received, this function is not exhibited, and thus it is polarity dependent. In order to impart this type of function, it is preferable that the atoms that control the conductivity in the anti-charge-injection layer are more the amount in the photoconductive layer.

The conductivity controlling atoms may be included in the layer may be completely uniformly distributed, or they may be distributed completely in the thickness direction but have some portions where they are unevenly distributed. In the case where the distribution density is uneven, it is preferable that the distribution is such that more atoms are included at the support body side.

The conductivity controlling atoms to be included in the layer include may be what is considered impurity in the semiconductor field, and atoms from group 3 of the periodic table that impart p-conductivity or atoms from group 5 of the periodic table that impart n-conductivity may be used. In the a-Si photosensitive body, in view of obtaining desired electrophotographic and economic effects, the layer thickness of the anti-charge-injection layer is preferably 0.1-5 μm, more preferably 0.3-4 μm, and optimally 0.5-3 μm.

Organic photoreceptor refers to an electrophotographic photoreceptor that is formed by imparting to an organic compound, one of functions necessary for an electrophotographic photoreceptor which functions are a charge generating function and a charge transferring function, and examples include all known organic electrophotographic photoreceptors such as photoreceptors comprising known organic charge generating substances or organic charge transferring substances, and photoreceptors comprising a high polymer complex which has a charge generating function and a charge transferring function.

In addition, surface layer simply refers the layer that is at the surface of the various layers that comprises the electrophotographic photoreceptor, and does not indicate any function. That is to say, in the case of an electrophotographic photoreceptor where an intermediate layer, a charge generating layer and a charge transferring layer are formed sequentially on a cylindrical base, the charge transferring layer is the surface layer, and when a protective layer is also formed, the protective layer is the surface layer.

The following is a description of the organic photoreceptor usable in this invention.

Cylindrical Base

The cylindrical base to be used in the cylindrical photoreceptor is a conductive base. Cylindrical conductive base refers to a cylindrical support body that is able to form images endlessly due to rotation, and a conductive base in which the straightness is not more than 0.1 mm and the deflection is not more than 0.1 mm is preferable. If this range of straightness or deflection is exceeded, favorable image formation will be difficult.

Substances that may be used as the conductive material include: a metal drum such as an aluminum or nickel drum, plastic drum vapor deposited with aluminum, stannic oxide, indium oxide or the like, or a paper or plastic drum onto which a conductive substance has been coated. The conductive substance preferably has a specific resistance of 10³ Ω cm or less.

Flexible Base

The material is not particularly limited, and as long as the material can have an endless belt structure, there will be no hindrances. Any generally known engineering plastic base may be used, and examples include polyethylene terephthalate, polyethylene naphthalate, polyether imide, polyether sulfone, polycarbonate, and polyarylate. The material used is not to be limited by these examples and it sufficient that the material has the characteristics of a belt support body. Of the above material that may be used for the support body, polyethylene naphthalate more easily satisfies this condition. In addition the film thickness of the belt support body is usually 50-200 μm in order for it to be simultaneously rigid and flexible.

Intermediate Layer

The intermediate layer (UCL) that may be formed in a photoreceptor is one that is provided between the base and the photosensitive layer in order to improve adhesive properties of the base and the photosensitive layer, or to prevent charge injection from the base. Examples of the material to be used for the intermediate layer are, polyamide resins, vinyl chloride resins, vinyl acetate resins, as well as copolymer resins comprising at least 2 repeated units of these resins. Of these resins, polyamide is preferable since the increase in rest potential when used repeatedly can be low. Also, the thickness of the intermediate layer which uses these resins is preferably 0.01-2 μm.

The most favorable form of the intermediate layer is one using a hard metallic resin in which an organo-metallic compound such as a silane coupling agent or a titanium coupling agent is thermally hardened. The thickness of the intermediate layer which uses the hard metallic resin is preferably 0.01-2.0 μm.

Another favorable intermediate layer is one which contains titanium oxide and a binder resin, and which is formed by dispersing the titanium oxide in the binder resin and then coating The thickness of the intermediate layer which uses the titanium oxide is preferably 0.01-15 μm.

In the case of a flexible base, usually the support body is insulated and generally coated with a conductive layer. The method for forming the conductive layer is one in which there vapor deposition or spattering of metals or metal oxide compounds such as aluminum or ITO (indium titanium oxide), or one in which conductive particles and resins such as ITO an alumina and the like are mixed.

Photosensitive Layer

The photosensitive layer may be a single layer structure of one layer that has both charge generating properties and charge transferring properties which is formed on the above-described intermediate layer. However, a separate structure in which a charge generating layer (CGL) has the charge generating function, and a charge transferring layer (CTL) has the charge transferring function is more preferable. By having the structure in which the functions are separated, the increase in rest potential caused by repeated use can be controlled so as to be small, and control is facilitated for other electrophotographic properties.

It is preferable the negative charge photoreceptor has a structure in which the charge generating layer (CGL) is on the intermediate layer, and the charge transferring layer (CTL) is on the charge generating layer (CGL). In the positive charge photoreceptor, the order is: base, intermediate layer, CTL then CGL.

The preferable configuration of the photosensitive layer of this invention is one in which the negative charge photoreceptor has the above-described functions provided separately.

The following is a description of the configuration of the photosensitive layer for the negative charge photoreceptor in which the functions are provided separately.

Charge Generating Layer

The charge generating layer comprises a charge generating substance and a binder resin, and the charge generating substance is dispersed in a binder resin solution and then coated to thereby form the layer.

A known phthalocyanine compound may be used as the charge generating substance. The phthalocyanine compound is preferably titanyl phthalbcyanine compound and hydroxygallium phthalocyanine compound. Also, Y type, A type (β type) and other titanyl phthalocyanine, and special titanyl phthalocyanine in which the main peak of the Bragg Angle 2θ corresponds to the Cu-Kα characteristic X-ray (wave length 1.54 Å) may be used. These oxytitanyl phthalocyanines are described in Japanese Patent Application Laid-Open No. 10-069107. In addition, these charge generating substances may be used singly, or 2 types or more types, such as Y type and A type may be used in combination, or may be mixed with a polycyclic quinine such as perylene pigment.

Any known binder resin may be used as the binder resin in the charge-generating layer, and examples include but are not limited to polystyrene resin, polyethylene resin, polypropylene resin, acrylic resin, methacrylic resin, vinyl chloride resin, vinyl acetate resin, polyvinyl butyral resin, epoxy resin, polyurethane resin, phenol resin, polyester resin, alkyd resin, polycarbonate resin, silicone resin, melamine resin, and copolymer resins including 2 or more of the above resins (such as vinyl chloride-vinyl acetate copolymer resin, vinyl chloride-vinyl acetate-maleic anhydride copolymer resin), and polyvinyl carbazole resin.

The charge generating layer is preferably formed by using a disperser to disperse a charge generating substance into solution into which the binder resin is dissolved by a solvent, to thereby prepare a coating solution, and coating the coating solution to form a coat of uniform thickness using a coating machine, and then drying the coating layer to thereby prepare the charge generating layer.

Examples of the solution that is used for dissolving and coating the binder resin to be used in the charge generating layer are toluene, xylene, methylene chloride, 1,2-dichloroethane, methylethyl ketone, cyclohexanone, ethyl acetate, butyl acetate, methanol, ethanol, propanol, methyl cellosolve, ethyl cellusolve, tetrahydrofluoran, 1-4 dioxane, 1-3 dioxane, pyridine and ethyl amine.

The dispersing means for the charge generating substance include, but are not limited to, an ultrasonic disperser, a ball mill, a sand grinder, a homogenizing mixer and the like.

Examples of the coating machine for forming the charge generating layer include but are not limited to an immersion coater, a ring coater, and the like.

The mixing proportion for the binder resin to the charge generating substance is preferably 100 parts by mass of binder resin to 1-600 parts (parts hereinafter refers to parts by mass) and more preferably 50-500 parts of the charge generating substance. The thickness of the charge generating layer is differs in accordance with properties of the charge generating substance, the properties of the binder resin, the mixing ratio and the like, but is preferably 0.01-5 μm.

Charge Transferring Layer

The charge transferring layer comprises a charge transferring substance and a binder resin, and the charge transferring substance is dissolved in a binder resin solution and then coated to form the layer.

Examples of the charge transferring substance include those described in the specification of Japanese Patent Application No. 2000-360998 as well as carbazole derivatives, oxazole derivatives, oxadiazole derivatives, thiazole derivatives, triazole derivatives, imidazole derivatives, imidazolone derivatives, imidozolidine derivatives, bis-imidozolidine derivatives, styryl compounds, hydrazone compounds, pyrazoline compounds, oxazolone derivatives, benzimidazole derivatives, quinazoline derivatives, benzofuran derivatives, acridine derivatives, phenazine derivatives, amino stilbene derivatives, triarylamine derivaties, phenylenediamine derivatives, stilbene derivatives, benzidene derivatives, poly-n-vinylcarboxyl, poly-1-vinylpyrene, and poly-9-vinyl anthracene of which two or more may be mixed and used.

The binder resin to be used in the charge transferring layer may be known resins such as polycarbonate resin, polyacrylate resin, polyester resin, polystyrene resin, styrene-acrylicnitryl copolymer resin, polymetacrylate ester resin and styrene metacrylate ester copolymer. However, the polycarbonate resin is preferable. In addition, polycarbonate BPA, BPZ, dimethyl BPA, BPA-dimethyl BPA copolymer and the like are preferable in view of crack and wear resistance and charge properties.

The formation of the charge transferring layer is preferably such that the binder resin and the charge transferring substance are dissolved to thereby prepare a coating solution, and the coating solution is coated in a film of uniform thickness using a coater, and the coating layer is then dried to thereby prepare the layer.

Examples of the solution that is used for dissolving the binder resin to be used in the charge transferring layer are toluene, xylene, methylene chloride, 1,2-dichloroethane, methylethyl ketone, cyclohexanone, ethyl acetate, butyl acetate, methanol, ethanol, propanol, butanol, tetrahydrofluoran, 1,4 dioxane, 1,3 dioxane, pyridine and ethyl amine. However, the solution is not limited to these examples.

The mixing proportions for the binder resin to the charge transferring substance is preferably 100 parts by mass of binder resin to 10-500 parts (parts hereinafter refers to parts by mass) and more preferably 20-100 parts of the charge transferring substance.

The thickness of the charge transferring layer differs in accordance with properties of the charge transferring substance, the properties of the binder resin, the mixing ratio and the like, but is preferably 10-100 μm, and more preferably 15-40 μm.

In addition an anti-oxidation agent (AO agent), an electron accepting substance (EA agent) and a stabilizing agent may be added to the charge transferring layer. The AO agent described in Japanese Patent Application No. 11-200135, and the EA agent described in Japanese Patent Laid-open Publication Nos. 50-137543 and 58-76483 may be used.

Protective Layer

In order to increase, durability, a protective layer may be disposed on top of the charge transferring layer. Protective layers that use siloxane resins are described in the publications of Japanese Patent Application Laid-open No. 9-190004, Japanese Patent Application Laid-open No. 10-095787, Japanese Patent Application Laid-open No. 2000-171990 improves the wear resistance, and is thus favorable. The most favorable layer configurations of the organic photoreceptor are described in the examples above, but they are not intended to exclude other layer configurations.

It is also favorable to include inorganic particles with an average particle diameter of 5-1000 nm in the surface layer of the photoreceptor. By including these inorganic particles in the surface layer of the photoreceptor, the wear strength of the organic photoreceptor is improved, and thus a highly durable organic photoreceptor can be obtained. Further, by causing this type of photoreceptor to have the end configuration of the present invention, abrasion and cutting of the cleaning blade is prevented and a cleaning method and a an image formation method are provided that allows high durability, prevent occurrence of cleaning defects, and provides high resolution images.

It is preferable that the above-described organic particles are organic particles that have been subjected to hydrophobic processing (for example that described in Japanese Patent Application Laid-open No. 8-248663), and are distributed in the surface layer of the photoreceptor, thus providing roughness to the surface in which they are included. The method for making the organic particles hydrophobic is a method of processing using hydrophobic processing agent such as titanium coupling agent, a silane coupling agent, a high polymer fatty acid, or metallic salts thereof.

Examples of the organic particles include particles of silica, titanium oxide, alumina, barium titanate, calcium titanate, strontium titanate, zinc oxide, magnesium oxide, zirconium oxide, barium sulfate, barium carbonate, calcium carbonate, silicon carbide, silicon nitride, chrome oxide, red iron oxide and the like.

As described above, it is preferable that the organic particles are subjected to hydrophobic processing. The hydrophobic processing may be carried out by reacting the organic particles and the hydrophobic processing agent at a high temperature. The hydrophobic processing agent is not particularly limited, and may for example be silane coupling agents such as hexamethyldisilazane, dimethyldichlorosilane, decylsilane, dialkyldihalogenized silane, trialkylhalogenized silane, alkyl trihalogenizedsilane and the like, or dimethyl silicone oil. The amount of the hydrophobic processing agent is different depending on the type of the particles and the like, and thus cannot be universally set, but generally if the amount is increased, the hydrophobic properties will increase. Also, it may be effective to remove moisture-absorbing substances by re-precipitation or heat processing.

It is to be noted that the average particle diameter may be enlarged 2000 times by observation under a transmission electronic microscope, and 100 particles may be observed as 1-dimensional particles, to thereby measure the value of the Fell direction average diameter by image analysis.

The image bearing body may be an intermediate transfer body. The intermediate transfer body may comprise, as necessary, the base and one or more layers disposed on the base. The layer is not particularly limited as long as it provides the functions necessary for image formation, and it may for example be a fluorine resin layer, a silicone rubber layer, a polyvinylchloride layer and the like.

The base useable for this intermediate transfer body may be the above-described cylindrical base or a flexible base. In the case of a flexible base, the material may be a polyimide, polyethylether ketone (PEEK), polyarylene sulfide (PAS), polyimide amide, polyether sulfone (PES) polyether nitryl (PEN), or athermoplastic polyimide, however, a polyimide is favorable in view of the requirement of thermal resistance and mechanical strength.

In the case where the intermediate transfer body has a cleaning means such a cleaning blade, the incline or undulation of the layer end can provide favorable cleaning properties.

In the following, the image forming device for use in the cylindrical photoreceptor prepared by the method for manufacturing a cylindrical photoreceptor of this invention will be described.

Image Forming Apparatus

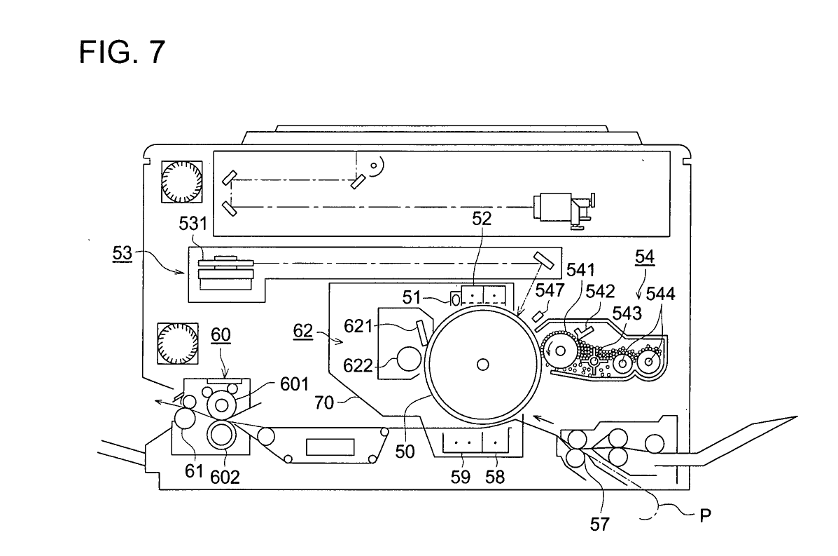

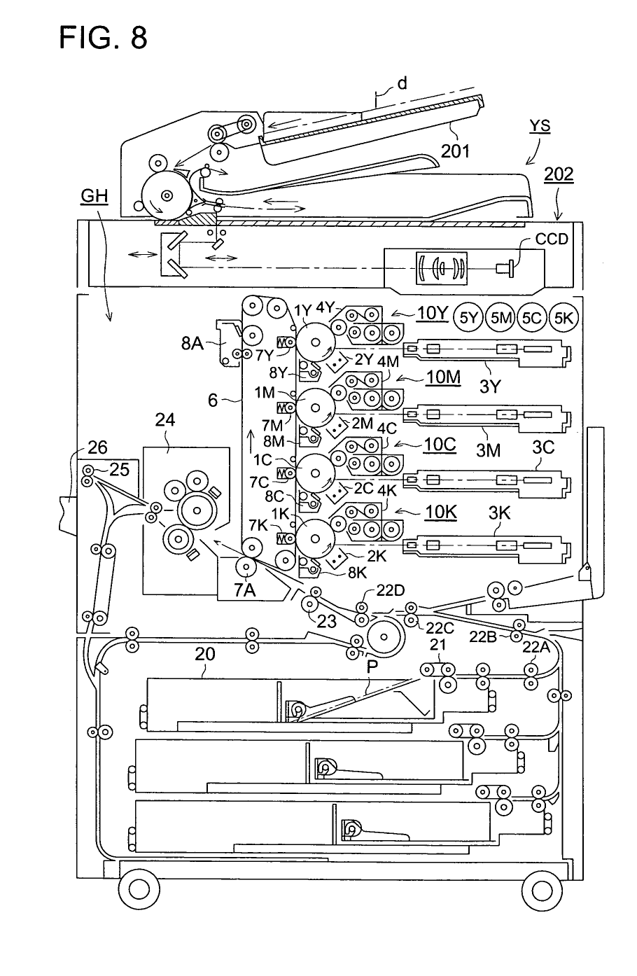

FIG. 7 is a cross-sectional view of an example of the image forming apparatus of this invention.

In FIG. 7, 50 is the photoreceptor drum (a photoreceptor), and an organic photosensitive layer is coated on the drum, a photoreceptor having the resin layer of this invention is applied, grounded, and then driven in the clockwise direction. 52 is a scorotron charging device (charging means), and applies uniform charge to the circumferential surface of the photoreceptor drum 50 using corona discharge. Before charging by the charging device 52, exposure may be done by the charge pre-exposure section 51 using a light emitting diode and the like in order to remove the historical data of the photoreceptor for the previous image formation, thereby removing the charge from the circumferential surface.

After uniform charging of the photoreceptor, the image exposing device 53, which is the image exposing means, carries out image exposure based on imaging signals. The image exposure device 53 in the drawing has a laser diode which is not shown as the light source for exposure. Scanning is done on the photoreceptor drum using light whose light path is curved using a reflection mirror via the rotating polygon mirror 531 and fθ lens and the like.

Here, the negative development process is an image forming method in which the charging device 52 uniformly charges the surface of the photoreceptor, and the region where image exposure was done, or in other words the exposed section electrical potential (exposed section region) makes an image visible using a development process (means). Meanwhile, the unexposed section electrical potential is not developed due to a development bias potential being applied to the development sleeve 541.

Next the electrostatic image is developed at the development device 54 which is the development means. The peripheral edge of the photoreceptor drum 50 is provided with the development device 54 which has therein a developing agent comprising toner and a carrier, and development is done by a rotating development sleeve 54 which has a magnet and holds the developing agent. The inside of the development device 54 comprises developing agent agitating and conveying members 544 and 543, conveying amount controlling member 542 and the like. The developing agent is agitated and conveyed, and then supplied to the development sleeve, and the supply amount is controlled by the conveying amount controlling member 542. The amount of the developing agent that is conveyed varies in accordance with the linear velocity and relative density of the organic electrophotographic receptor, but is generally in the range of 20-200 mg/cm³.

The developing agent comprises a core of the above-mentioned ferrite, and on the core, is a substance comprising coloring particles including: a carrier coated with an insulating resin, a coloring agent such as carbon black with a styrene acrylic resin as its main component; a charge controlling agent, and the low molecular weight polyolefin of this invention; and toner comprising added silica, titanium oxide, and the developing agent is conveyed to the developing region such that the layer thickness is controlled by the conveying amount controlling member. At this time, direct current bias, and if necessary alternating current bias voltage is normally applied between the photoreceptor drum 50 and the development sleeve 541, and development is carried out. Also, the developing agent may develop the photoreceptor in a contact state or in a non-contact state. Measuring of the electric potential of the photoreceptor is done by the electric potential sensor 547 which is provided at the upper part of the development position as shown in FIG. 7.

The recording paper P is fed to the transfer region due to the rotation operation of the paper feed roller 57 after the image formation and when the transfer timing is set. In the transfer region, the transfer electrode (transfer means: transfer device) 58 operates on the circumferential surface of the photoreceptor drum 50 in a timing that is synchronized with the transfer timing, and toner and charge of the opposite polarity is applied to the paper P that was fed, and the toner is transferred.

Next the recording paper P is subjected to charge removal by the separation electrode (separation device) 59, and then separated from the circumferential surface of the photoreceptor drum 50, and then conveyed to the fixing apparatus 60, and heat is applied by the heat roller 601 and the pressure roller 602, and after the toner is deposited, the recording paper P is discharged to the apparatus exterior via the discharge roller 61. It is to be noted that the transfer electrode 58 and the separation electrode 59 temporarily cease to operate after the recording paper P has passed through, and prepare for the next toner image formation. In FIG. 7, the transfer electrode 58 uses a scorotron transfer electrode. The setting conditions for the transfer electrode vary in accordance with photoreceptor processing speed (circumferential speed) and the like and thus cannot be universally defined, but the value for the transfer current may be +100-+400 μA; the value for the transfer voltage may be +500-+200V.

Meanwhile, the residual toner is removed/cleaned from the photoreceptor drum 50 after the recording paper P has been separated, by pressure contact of the cleaning blade 621 of the cleaning device (cleaning means) 62, and the electrical charge is once again removed by the charge pre-exposure section 51, and then electrical charge is received from the charger 52, and then the next image formation process begins. It is to be noted that the cleaning blade 621 has a thickness of about 1-30 mm and uses an elastic rubber body, and is often formed of urethane rubber.

70 is a removable process cartridge in which the charger, the transfer device, and the cleaning device are integrally formed.

The organic electrophotographic photoreceptor of this invention may generally be applied to electrophotographic devices such as an electrophotographic copier, a laser printer, a LED printer, a crystal shutter printer and the like. It may be further applied to devices using electrophotographic technology such as display, recording, light printing, plate making, and facsimile devices, and thus may be widely applied.

### EMBODIMENT

The following is a description of the present invention using examples. However, configurations of this invention are not limited to these embodiments.

### Embodiment 1

### Preparation of the Cylindrical Photoreceptor

An aluminum drum base with an outer diameter of 80 mm and length of 355 mm that was subjected to mirror surface processing was used as the cylindrical conductive base.

The intermediate layer coating solution below is prepared and coated by immersion on the base, such that the dry thickness is 1.0 μm.

Intermediate Layer Coating Solution

| | | |
|---|---|---|
| Ethylene-vinyl acetate copolymer | 50 | g |
| (Elbax 4260: Manufactured by Mitsui Dupont Chemicals) | | |
| Toluene/n-butane = 5/1 volume ratio | 2000 | ml |

The charge generating layer coating solution below is prepared by dispersion and coated by immersion on this intermediate layer, such that the dry thickness is 0.5 μm.

Charge generating layer coating solution

| | | |
|---|---|---|
| Titanyl phthalocyanine pigment | 100 | g |
| Silicone resin (KR-5240 Manufactured by Shinetsu Chemical | 100 | g |
| Co., Ltd.) | | |
| t-butyl acetate | 1000 | ml |
| The above components of the coating solution are dispersed | | |
| for 17 hours using a sand mill. | | |
| Charge transferring layer coating solution | | |
| Charge transferring substance: ([4-(2,2-diphenylvinyl)phenyl] | 500 | g |
| diparatryl amine) | | |
| Polycarbonate (Z-200: Manufactured by Mitsubishi Gas Co., | 560 | g |
| Ltd.) | | |
| Hydrophobic silica (average particle diameter: 50 nm) | 50 | g |
| Dioxolane (bp 74-75° C.) | 2800 | ml |
| Methyl phenyl silicone oil (KF-54 Manufactured by Shinetsu | | |
| Chemical Co., Ltd.) 100 ppm for all the components | | |

The charge transferring layer coating solution described above is prepared and coated by immersion on the charge generating layer, such that the dry thickness is 23 μm, and in the device shown in FIG. 4, the portion where the coating solution accumulates (approximately 20 mm from the photoreceptor base end) that is formed on the end thereof is removed by a method described in “Method for removing a coating layer using a brush” to thereby change the coating layer end track. Drying is then done to thereby prepare the cylindrical photoreceptors 1-6. The undulation widths or the incline widths of the coating layer end tracks of the cylindrical photoreceptor are shown in Table 1.

The above-described photoreceptors 1-6 are loaded in the Konica 7050, (Corona charge, laser exposure, negative development, electrostatic transfer, claw separation, process using blade cleaning, print speed 50 sheets/minute) which is a copier manufactured by Konica and has the structure shown in FIG. 7, and 200,000 sheets of A4 paper are printed in a 24° C. and 60% RH environment, and then the cleaning properties and the wear or cutting of the cleaning blade is evaluated.

Cleaning Conditions

A cleaning blade with a rigidity of 70°, impact resilience of 65%, length of 2 (mm) and free length of 9 mm was brought in contact with the cleaning section in a dense load mode such that the cleaning blade has a linear pressure of 18 (N/m) in the counter direction. A cleaning blade with a length of 345 mm was used and an interval of 5 mm was provided between both ends of the photoreceptors.

The results of the evaluation are shown in Table 1.

TABLE 1

| | | End track | | Evaluation |
|---|---|---|---|---|
| | | undulation | | of |
| Photo- | | width or | | cleaning |
| sensitive | Coating | incline | | blade wear |
| body | layer end | width h | Evaluation of cleaning | and |
| No. | track | (mm) | properties | breakage |
| 1 | p in | 9 | No cleaning defects on | No |
| | FIG. 3(a) | | completion of 200,000 | evidence |
| | | | copies | of wear or |
| | | | | breakage |
| | | | | of blade |
| 2 | q in | 7 | Same as above | Same as |
| | FIG. 3(b) | | | above |
| 3 | r in | 2 | Same as above | Same as |
| | FIG. 3(c) | | | above |
| 4 | s in | 5 | Same as above | Same as |
| | FIG. 3(d) | | | above |
| 5 | p in | 1 | Some occurrence of | Vague |
| | FIG. 3(a) | | toner transfer faults | evidence |
| | | | between 180,000 and | of wear of |
| | | | 200,000 sheets | blade |
| 6 | a in | 0.2 | Toner transfer faults | Clear |
| | FIG. 3(a) | | after 120,000 copies | evidence |
| | | | | of wear of |
| | | | | blade |

As seen from Table 1, cylindrical photoreceptors 1-5 that have the coating layer end track have favorable cleaning properties, and in cylindrical photoreceptors 1-4 in particular, evaluation after 200,000 copies were made did not show any cleaning defects. For cylindrical photoreceptor 5, after about 180,000 copies toner transfer faults occurred, and for cylindrical photoreceptor 6, after about 120,000 copies toner transfer faults occurred. Also in cylindrical photoreceptors 1-4, there was no evidence of wear of the cleaning blade at the portion of contact with the coating layer end track, while in cylindrical photoreceptors 5-6 there was slight evidence or clear evidence of wear, and thus favorable incline or undulation levels became clear.

As shown in the examples, by using the cylindrical image bearing body (a cylindrical image bearing body in which the lower unnecessary coating film is removed and the end track after removal of the coating film is made into an incline or an undulation), wear or breakage of specific portions of the cleaning blade can be reduced and an electrophotographic image in which cleaning properties are favorable can be obtained.

1. An electrophotographic image bearing body comprising a base and a surface layer disposed over the base, wherein the end track of the surface layer undulates or inclines with respect to the outer circumference of the image bearing body.

2. The electrophotographic image bearing body of claim 1, being a photoreceptor.

3. The electrophotographic image bearing body of claim 2, wherein the undulation width or the incline width of the end track is not less than 0.5 mm and not greater than 10 mm.

4. The electrophotographic image bearing body of claim 2, wherein the surface layer comprises inorganic particles.

5. The electrophotographic image bearing body of claim 4, wherein the surface layer comprises a photosensitive layer.

6. The electrophotographic image bearing body of claim 5, wherein the photosensitive layer comprises a charge transferring layer having a thickness of 15 to 40 μm and a charge generating layer having a thickness of 0.01 to 5 μm.

7. The electrophotographic image bearing body of claim 6, wherein the width of the undulation or incline of the end track is not less than 2 mm and not more than 8 mm.

8. The electrophotographic image bearing body of claim 2, wherein the width of the undulation or incline of the end track is not less than 2 mm and not more than 8 mm.

9. The electrophotographic image bearing body of claim 2, wherein the undulation or incline of the end portion is formed by exposing the base portion by removing a part of all the layers formed on the photoreceptor.

10. The electrophotographic image bearing body of claim 1, wherein the width of the undulation or incline of the end track is not less than 0.5 mm and not more than 10 mm.

11. The electrophotographic image bearing body of claim 10, wherein the width of the undulation or incline of the end track is not less than 2 mm and not more than 8 mm.

12. The electrophotographic image bearing body of claim 1, wherein the surface layer comprises inorganic particles.

13. The electrophotographic image bearing body of claim 1, wherein the undulation or incline of the end portion is formed by exposing the base portion by removing a part of all the layers formed on the image bearing body.

14. A method for producing an image bearing body comprising: providing a surface layer over a base, removing an edge of the surface layer so as to make an end track having undulation or incline with respect to outer circumference line of the image bearing body.

15. The method of claim 12, wherein the removing step comprises rotating the base relative to the sliding member, bringing the layer end in contact with the sliding member which has been impregnated with a solvent, and simultaneously moving the base in the central axis direction of the base and removing the end of the coating layer.

16. The method of claim 12, wherein the image bearing body is a photoreceptor.

17. An image forming method comprising: developing a latent image formed on a photoreceptor comprising a layer disposed over a base, the photoreceptor comprising an end track of the surface layer which undulates or inclines with respect to the outer circumference line of the photoreceptor; transferring a toner image formed on the photoreceptor to a transfer medium; and cleaning the toner remaining on the photoreceptor after the transferring.

18. The method of claim 17, comprising second developing a second latent image formed on second photoreceptor comprising a layer disposed over a base, the second photoreceptor comprising an end track of the surface layer which undulates or inclines with respect to the outer circumference line of the photoreceptor; transferring a second toner images formed on the second photoreceptor to the transfer medium; and cleaning the toner remaining on the second photoreceptor after the transferring.

19. An image forming apparatus comprising an electrophotographic photoreceptor as defined in claim 1.

20. The image forming apparatus of claim 1, comprising at least two of the electrophotographic photoreceptors as defined in claim 1.
